(19) United States
(12) Patent Application Publication
(10) Pub. No.: US 2007/0147027 A1
(43) Pub. Date: Jun. 28, 2007

(54) Safety helmet with a direction indicating device

(76) Inventor: Po-Chien Chuang, Yongkang City (TW)

Correspondence Address: BACON & THOMAS, PLLC, 625 SLATERS LANE, FOURTH FLOOR, ALEXANDRIA, VA, 22314, US

(21) Appl. No.: 11/313,673

(22) Filed: Dec. 22, 2005

(51) Int. Cl. F21V 21/084

(52) U.S. Cl. 362/106

(57) ABSTRACT

A safety helmet has a helmet body and a direction indicating device mounted on the helmet body. The direction indicating device has a left emitting assembly and a right emitting assembly. The left emitting assembly and right emitting assembly are mounted on the helmet body opposite to each other and both have a lamp, a tilt switch and a driving circuit. The driving circuit is connected electrically between the lamp and tilt switch. When the rider wearing the safety helmet tilts his/her head, the tilt switch makes the driving circuit in a closed circuit condition to light the lamp so as to provide a warning effect to other vehicle drivers with the lighting lamp.

### BACKGROUND OF THE INVENTION

1. Field of the Invention

The present invention relates to a safety helmet, and more particularly to a safety helmet with a direction indicating device.

2. Description of the Related Art

A two-wheel vehicle is equipped with turn signal lights. When a rider of the two-wheel vehicle intends to change lanes or turn directions, the rider switches on the turn signal lights to emit light for warning other vehicle drivers to prevent traffic accidents from occurring.

However, the turn signal lights are mounted in a low position of the two-wheel vehicle, the other vehicle drivers are not easy see the light emitting from the turn signal lights when traffic jam such that traffic accidents easily occur.

### SUMMARY OF THE INVENTION

The primary objective of the present invention is to provide a safety helmet with a direction indicating device for a two-wheel vehicle rider. When the rider wears the safety helmet, the direction indicating device can provide a clear warning effect to other vehicle drivers when he/her wants to change lanes or turn directions.

The safety helmet with a direction indicating device in accordance with the present invention comprises a helmet body and a direction indicating device.

The direction indicating device is mounted on the helmet body and has a left emitting assembly and a right emitting assembly. The left emitting assembly and right emitting assembly are mounted on the helmet body opposite to each other and both have a lamp, a tilt switch and a driving circuit and a power supply. The driving circuit is connected electrically between the lamp and tilt switch. The power supply is connected electrically to the driving circuit and provide electricity to the driving circuit and the lamp. When the rider wearing the safety helmet with a direction indicating device tilts his/her head left, the tilt switch of the left emitting assembly makes the driving circuit in short-circuit condition and the lamp of the left emitting assembly emits light. Likewise, when the rider tilts his/her head right, the lamp of the right emitting assembly emits light.

The light emitting from the safety helmet is in high position and easy saw by other vehicle drivers. The light emitting from the safety helmet apprise other vehicle drivers which lane the rider want to changes and which direction the rider want to turn, and avoid traffic accidents happening.

### BRIEF DESCRIPTION OF THE DRAWINGS

FIG. 1 is a rear view in partial cross section of a first embodiment of a safety helmet with a direction indicating device in accordance with the present invention;

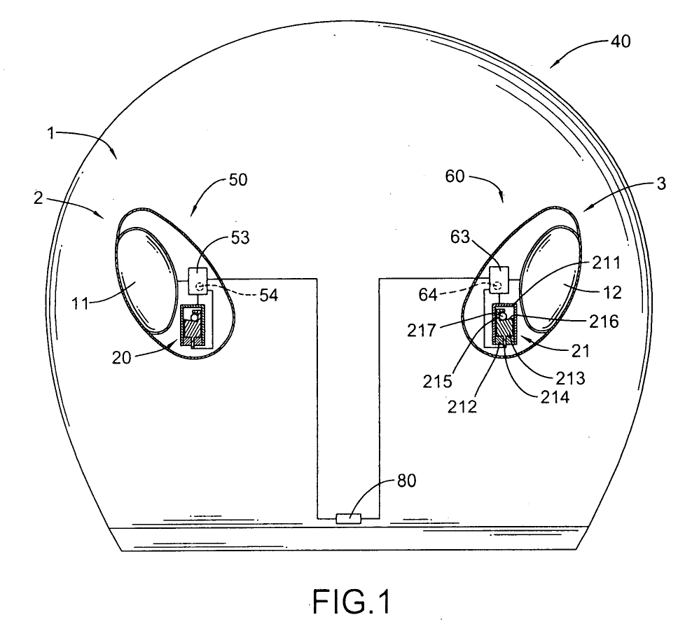

FIG. 2 is rear view in partial cross section of a tilt switch of the safety helmet in FIG. 1;

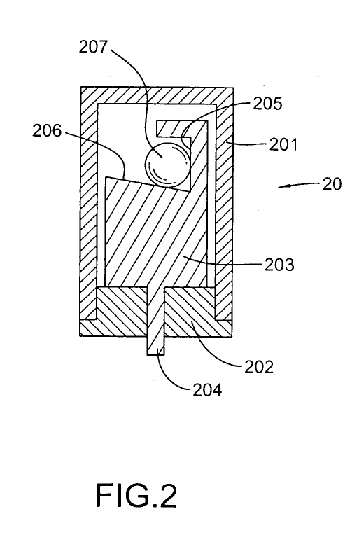

FIG. 3 is an operational rear view in partial cross section of the safety helmet in FIG. 1 showing that the safety helmet is tilted to a left side;

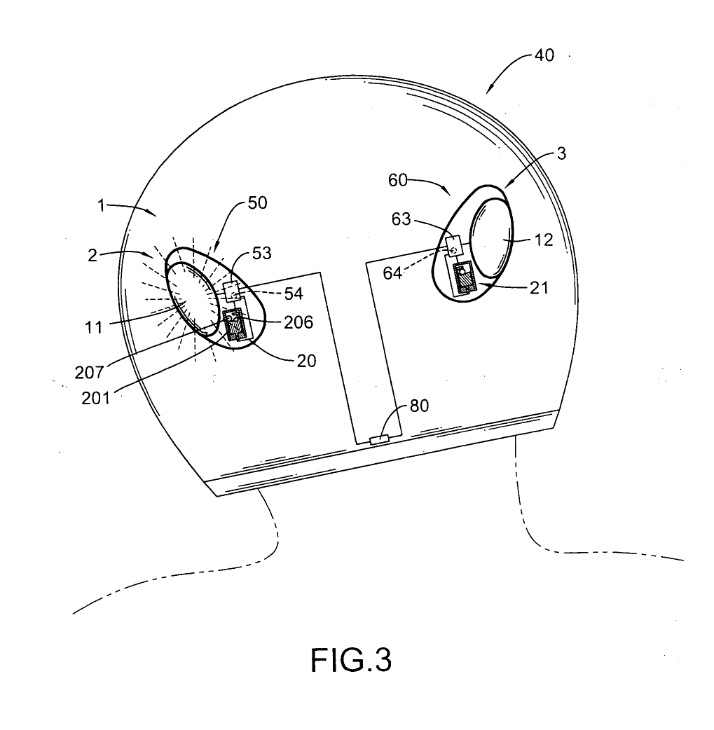

FIG. 4 is an operational rear view in partial cross section of the safety helmet in FIG. 1 showing that the safety helmet is tilted to a right side;

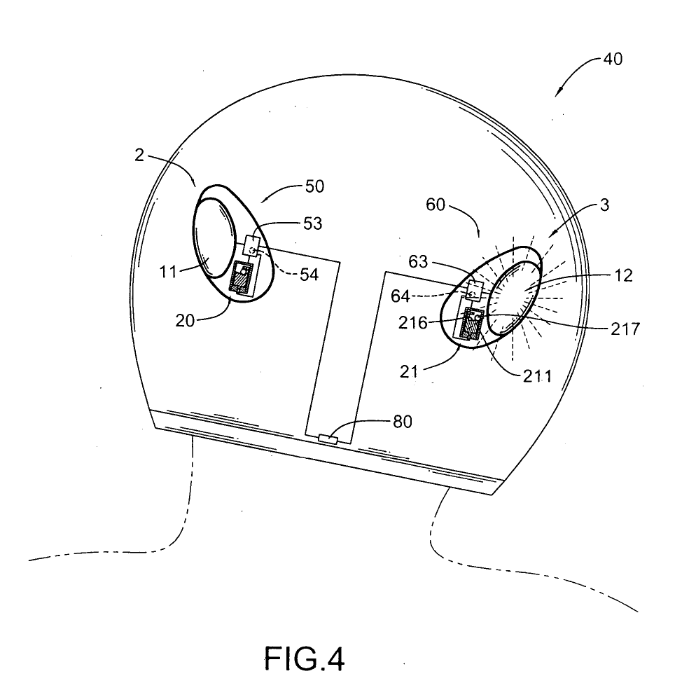

FIG. 5 is a rear view in partial cross section of a second embodiment of a safety helmet with a direction indicating device in accordance with the present invention;

FIG. 6 is a rear view in partial cross section of a third embodiment of a safety helmet with a direction indicating device in accordance with the present invention;

FIG. 7 is an operational rear view in partial cross section of the safety helmet in FIG. 6; and

FIG. 8 is a rear view in partial cross section of a forth embodiment of a safety helmet with a direction indicating device in accordance with the present invention.

### DETAILED DESCRIPTION OF THE PREFERRED EMBODIMENT

With reference to FIG. 14, a safety helmet with a direction indicating device in accordance with the present invention comprises a helmet body (40) and a direction indicating device (1).

The helmet body (40) has a left side, a right side and a center.

The direction indicating device (1) is mounted on the helmet body (40) and may be implemented in several ways.

A first embodiment of the direction indicating device (1) comprises a left emitting assembly (2), a right emitting assembly (3), an optional power switch (80), an optional left bracket (50) and an optional right bracket (60).

The left emitting assembly (2) and right emitting assembly (3) are mounted respectively on the left side and the right side of the helmet body (40) and each have a lamp (11)(12), a tilt switch (20)(21), a driving circuit (53)(63) and a power supply (54)(64). The tilt switch (20)(21) is connected electrically to the lamp (11)(12) to switch on the lamp (11)(12) when the tilt switch (20)(21) tilts toward a predetermined direction. The tilt switch (20)(21) has a metal shell (201)(211), an insulation base (202)(212), a conductive member (203)(213) and a metal ball (207)(217). The metal shell (201)(211) is mounted in the helmet body (40) and has an open end. The insulation base (202)(212) is mounted in the open end of the metal shell (201)(211) and has a through hole.

The conductive member (203)(213) is mounted in the metal shell (201)(211) and has a body, a conductive rod (204)(214) and a lateral cavity (205)(215). The body of the conductive member (203)(213) is mounted in the metal shell (201)(211). The conductive rod (204)(214) extends from the body of the conductive member (203)(213) and through the through hole in the insulation base (202)(212). The lateral cavity (205)(215) is defined laterally in the body of the conductive member (203)(213) and has an inclined bottom surface (206)(216). The inclined bottom surface (206)(216) descends toward the center of the helmet body (40) and at a preferred angle from 10 degrees to 45 degrees. An insulating space is defined between the conductive member (203)(213) and the metal shell (201)(211).

The metal ball (207)(217) is mounted rotatably and slidably in the lateral cavity (205)(215) of the conductive member (203)(213). When the tilt switch (20)(21) is not at a tilted condition, the metal ball (207)(217) stays in the lateral cavity (205)(215) and does not contact with the metal shell (201)(211) such that an opened circuit loop is formed between the metal shell (201)(211) and the conductive member (203)(213). When the tilt switch (20)(21) is tilted toward a desired direction, the metal ball (207)(217) rolls to contact with the metal shell (207)(217) due to gravity to form a closed circuit loop between the metal shell (201)(211) and the conductive member (203)(213).

The driving circuit (53)(63) is connected electrically between the tilt switch (20)(21) and the lamp (11)(12), and is connected electrically between the metal shell (201)(211) and the conductive rod (204)(214) of the conductive member (203)(213) of the tilt switch (20)(21) in series. When the metal ball (207)(217) stays in the lateral cavity (205)(215) of the conductive member (203)(213) of the tilt switch (20)(21) and does not contact the metal shell (201)(211), the driving circuit (53)(63) is in an opened circuit condition and the lamp (11)(12) does not emit light. When the metal ball (207)(217) rolls to contact with the metal shell (201)(211) and the conductive member (203)(213) while the tilt switch (20) is tilted, the driving circuit (53)(63) is in a closed circuit condition and the lamp (11)(12) emits light. In addition, when the metal ball (207)(217) leaves the position where contacting with the metal shell (201)(211), the driving circuit (53)(63) can control the lamp (11)(12) to remain emitting for a predetermined time.

The power supply (54)(64) is connected electrically to the driving circuit (53)(63) to provide an electrical power to the driving circuit (53)(63) and lamp (11)(12). The power supply (54)(64) can be a dry battery or a solar battery.

The power switch (80) is connected electrically between the driving circuit (53) of the left emitting assembly (2) and the driving circuit (63) of the right emitting assembly (3). The power switch (80) is used to switch on or off the direction indicating device.

The left bracket (50) and right bracket (60) are mounted respectively on the left side and the right side of the helmet body (40). The left emitting assembly (2) and right emitting assembly (3) are mounted respectively in the left bracket (50) and right bracket (60). The power switch (80) is mounted on the helmet body (40) between the left bracket (50) and right bracket (60).

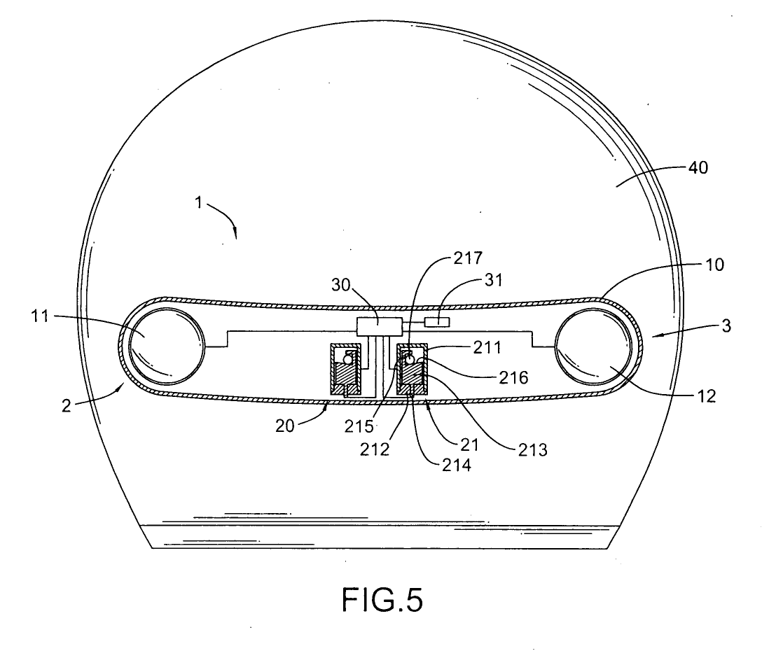

With reference to FIG. 5, in a second embodiment, the direction indicating device (1) comprises a left emitting assembly (2), a right emitting assembly (3), and a bracket (10). The bracket (10) is mounted on the helmet body (40). The left emitting assembly (2) and right emitting assembly (3) are mounted in the bracket (10) and opposite to each other, wherein the driving circuit (53) of the left emitting assembly (2) and the driving circuit (63) of the right emitting assembly are integrated into a control device (30), and the power supply (54) of the left emitting assembly (2) and the power supply (64) of the right emitting assembly (3) are integrated into a power supply device (31).

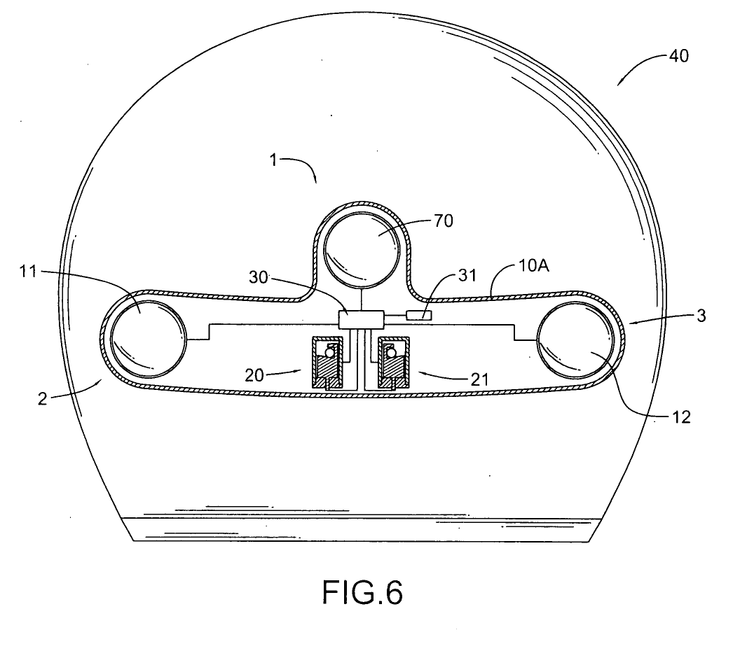

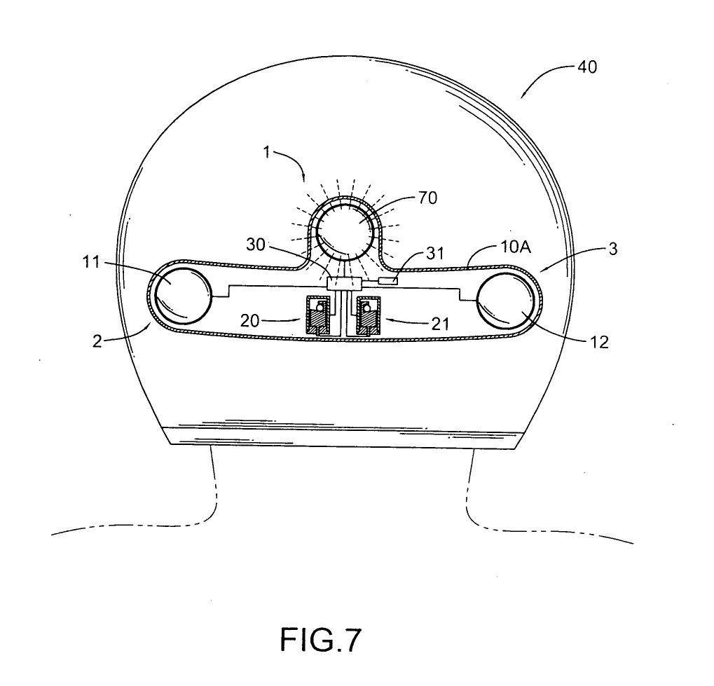

With reference to FIGS. 6 and 7, a third embodiment of a direction indicating device (1) is similar to the second embodiment as described and further comprises a warning lamp (70). The warning lamp (70) is mounted in the bracket (10A) and is connected electrically to the control device (30). When the left emitting assembly (2) or right emitting assembly (3) does not emit light, the warning lamp (70) is switched on to emit light for warning other vehicle drivers to keep a safety distance with the user. When the left emitting assembly (2) or right emitting assembly (3) is switched on to emit light, the warning lamp (70) is turned off by the control device (30).

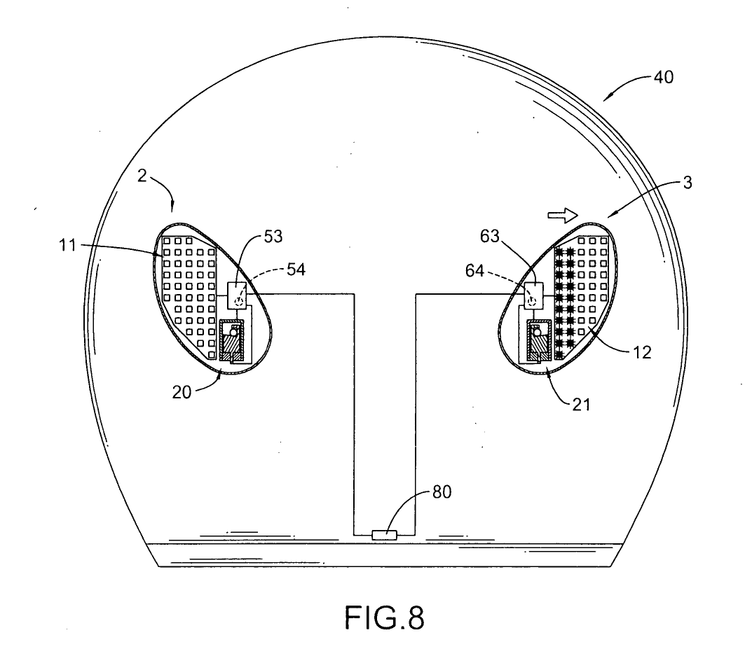

With further reference to FIG. 8, a forth embodiment of a direction indicating device (1) is similar to the first embodiment as described, the lamp (11)(12) may comprises multiple light-emitting diodes (LED) connected electrically to the driving circuit (54)(63). The multiple light-emitting diodes may emit light alternatively and may emit light with multiple colors to provide a versatile and various warning effect.

When a rider wearing the safety helmet with a direction indicating device tilts his/her head left, the metal ball (207) rolls to contact with the metal shell (201) to form a closed circuit loop between the metal ball (207) and conductive member (203), and the driving circuit (53) is in a closed-circuit condition such that the left emitting assembly emits light. Likewise, when the rider tilts his/her head right, the right emitting assembly emits light. Light emitting from the left emitting assembly or right emitting assembly provides a warning effect to other vehicle drivers to avoid traffic accidents from occurring when the rider turns right or left.

What is claimed is:

1. A safety helmet comprising
a helmet body having
a left side
a right side; and
a center; and
a direction indicating device mounted on the helmet body and having
a left emitting assembly and a right emitting assembly mounted respectively on the left side and right side of the helmet body and each having
a lamp mounted on a corresponding side of the helmet body; and
a tilt switch connected electrically to the lamp and having
a metal shell mounted on the helmet body and having an open end;
an insulation base mounted in the open end of the metal shell and having a through hole;
a conductive member mounted in the metal shell and having
a body mounted in the metal shell;
a conductive rod extending from the body of the conductive member and through the through hole in the insulation base; and
′a lateral cavity defined laterally in the body of the conductive member and having an inclined bottom surface descending toward the center of the helmet body, wherein an insulating space is defined between the conductive member and the metal shell; and
a metal ball mounted rotatably and slidably in the lateral cavity of the conductive member;
a driving circuit connected electrically between the tilt switch and the lamp, and connected electrically between the metal shell and the conductive rod of the conductive member of the tilt switch in series; and
a power supply connected electrically to the driving circuit to provide an electrical power to the driving circuit and lamp.

2. The safety helmet as claimed in claim 1, wherein
the direction indicating device further comprises
a left bracket mounted on the left side of the helmet body; and
a right bracket mounted on the right side of the helmet body;
the left emitting assembly is mounted in the left bracket; and
the right emitting assembly is mounted in the right bracket.

3. The safety helmet as claimed in claim 1, wherein
the direction indicating device further comprises a bracket mounted on the helmet body;
the left emitting assembly is mounted in the bracket;
the right emitting assembly is mounted in the bracket and opposite to the left emitting assembly;
the driving circuit of the left emitting assembly and the driving circuit of the right emitting assembly are integrated into a single control device; and
the power supply of the left emitting assembly and the power supply of the right emitting assembly are integrated into a single power supply device.

4. The safety helmet as claimed in claim 3, wherein the direction indicating device further comprises a warning lamp mounted in the bracket and connected electrically to the single control device.

5. The safety helmet as claimed in claim 1, wherein the direction indicating device further comprises a power switch connected electrically between the driving circuit of the left emitting assembly and the driving circuit of the right emitting assembly.
